(19) United States
(12) Patent Application Publication
(10) Pub. No.: US 2024/0014470 A1
(43) Pub. Date: Jan. 11, 2024

(54) BATTERY CELLS WITH DUAL-LAYERED CAPACITIVE CABODE ELECTRODES HAVING HIGH CAPACITOR RATIOS

(71) Applicant: GM GLOBAL TECHNOLOGY OPERATIONS LLC, Detroit, MI (US)

(72) Inventors: Dewen KONG, Shanghai (CN); Jingyuan LIU, Shanghai (CN); Haijing LIU, Shanghai (CN); Dave G. RICH, Sterling Heights, MI (US); Christian FAU, Northville, MI (US)

(21) Appl. No.: 17/886,975

(22) Filed: Aug. 12, 2022

(30) Foreign Application Priority Data
Jul. 5, 2022 (CN) 202210782685.4

(51) Int. Cl. H01M 16/00

(52) U.S. Cl. CPC H01M 16/003; H01M 4/131

(57) ABSTRACT

A battery cell comprises C electrodes each including a first current collector, first and second capacitive layers, and first and second active material layers. The first and second capacitive layers and the first and second active material layers are arranged on the first current collector. E anode electrodes include a second current collector and third and fourth active material layers arranged on the second current collector. E and C are integers greater than zero.

### CROSS-REFERENCE TO RELATED APPLICATIONS

This application claims the benefit of Chinese Patent Application No. 202210782685.4, filed on Jul. 5, 2022. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells with dual-layered capacitive cabode electrodes having high capacitor ratios.

Low voltage automotive battery systems such as 12V or 24V battery systems can be used for starting vehicles including an internal combustion engine (ICE) and/or to support vehicle accessory loads or other vehicle systems for these types of vehicles. Low voltage automotive battery systems can also be used to support vehicle accessory loads in electric vehicles (EVs) such as battery electric vehicles, hybrid vehicles and/or fuel cell vehicles. In some applications, the battery systems use lithium-ion battery cells due to their increased pulsed power density at both warm and cold temperatures and lower weight.

During starting, the battery system supplies current to a starter to crank the engine. When the vehicle is cold started, the battery needs to supply sufficient cranking power to overcome the pressure resistance at the top of the piston to create sufficient heat in the cylinder to ignite the injected fuel. In some applications, the battery system may continue to supply power for various electrical systems of the vehicle after the engine is started. An alternator or regeneration recharges the battery system.

### SUMMARY

To be inserted by attorney after inventor review.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross-sectional view of an example of a battery cell including anode electrodes and dual-layered capacitive cabode electrodes in a stacking cell architecture according to the present disclosure;

FIG. 2 is a cross-sectional view of an example of a dual-layered capacitive cabode electrode in the battery cell of FIG. 1 according to the present disclosure;

FIG. 3 is a cross-sectional view of an example of an anode electrode in the battery cell of FIG. 1 according to the present disclosure;

FIG. 4A illustrates a battery cell including a winding cell architecture including anode electrodes and dual-layered capacitive cabode electrodes according to the present disclosure;

FIG. 4B illustrates a pouch battery cell including anode electrodes and dual-layered capacitive cabode electrodes in a winding cell architecture according to the present disclosure;

FIG. 4C illustrates a prismatic battery cell including anode electrodes and dual-layered capacitive cabode electrodes in a winding cell architecture according to the present disclosure;

FIGS. 5A and 5B illustrate a battery cell including a winding cell architecture for cylindrical battery cells including anode electrodes and dual-layered capacitive cabode electrodes according to the present disclosure;

FIGS. 6A to 6C includes graphs illustrating cold cranking of battery cells including anode electrodes and dual-layered capacitive cabode electrodes according to the present disclosure;

FIG. 7 is a cross-sectional view of another example of a battery cell including pairs of anode electrodes and dual-layered capacitive cabode electrodes according to the present disclosure;

FIG. 8 is a cross-sectional view of an example of a dual-layered capacitive cabode electrode in the battery cell of FIG. 7 according to the present disclosure;

FIG. 9 is a cross-sectional view of an example of an anode electrode in the battery cell of FIG. 7 according to the present disclosure;

FIGS. 10A to 100 includes graphs illustrating cold cranking of battery cells including anode electrodes and dual-layered capacitive cabode electrodes according to the present disclosure; and

FIG. 11 illustrates a method for manufacturing the battery cells according to the present disclosure.

In the drawings, reference numbers may be reused to identify similar and/or identical elements.

### DETAILED DESCRIPTION

While the battery cells according to the present disclosure are described below in the context of a vehicle, the battery cells according to the present disclosure can be used in other applications.

The battery cell according to the present disclosure includes anode electrodes and dual-layered capacitive cabode electrodes. The dual-layered capacitive cabode electrodes include layers of cathode material (e.g., lithium iron phosphate (LFP) or other material) and layers of capacitor material (e.g., activated carbon (AC) or other material) arranged on a current collector. Capacity and power of the battery cell can be tailored by varying the relative thicknesses of the cathode material and the capacitor material in the dual-layered capacitive cabode electrodes. The battery cells can be produced in a variety of form factors using existing manufacturing processes and production lines.

In some examples, the battery cell design is capable of outputting 250 ms to 1000 ms simultaneous pulses and 10 s to 30 s pulse power. In some examples, a battery including the battery cells described herein can output very high crank power (15 kW) for a longer duration (e.g., 3 s to 20 s) during cold start cranking. As can be appreciated, the capacitor hybridization ratio can be customized by varying or tuning the thickness ratio of the capacitor layer and active material layer.

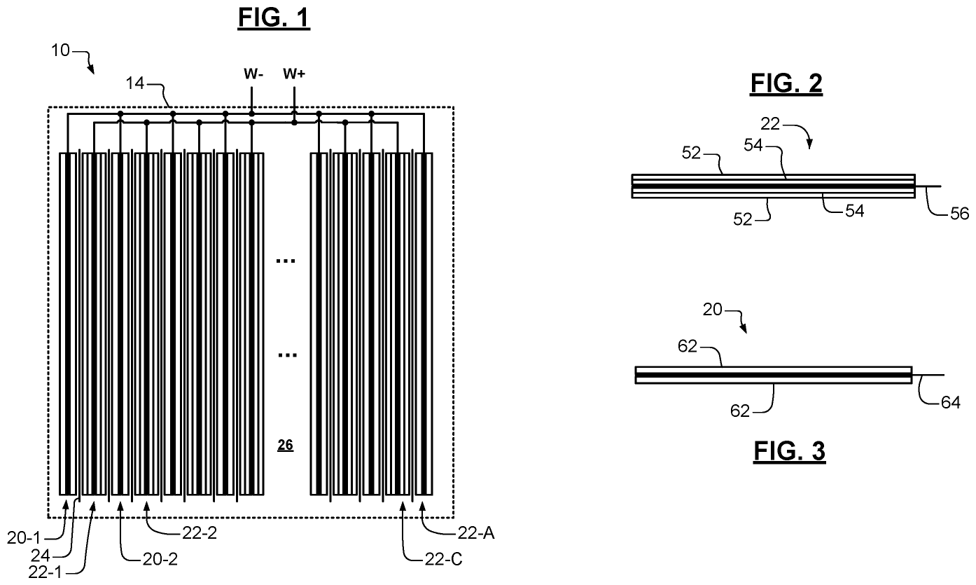

Referring now to FIGS. 1 to 3, a battery cell 10 is arranged in an enclosure 14, and includes anode electrodes 20-1, 20-2, . . . , and 20-A (collectively or individually referred to as anode electrodes 20) and dual-layered capacitive cabode electrodes 22-1, 22-2, . . . and 22-C (collectively or individually referred to as dual-layered capacitive cabode electrodes 22), where A and C are integers greater than zero. In some examples, A is equal to C+1, although other values can be used. The anode electrodes 20 and the dual-layered capacitive cabode electrodes 22 are spaced apart by separators 24 and immersed in electrolyte 26 such as liquid electrolyte or semi solid-state electrolyte. In other words, the separators 24 are arranged between the positive and negative electrodes.

In FIG. 2, the dual-layered capacitive cabode electrodes 22 are shown to include a current collector 56, capacitive layers 54 arranged on outer surfaces of the current collector 56, and active material layers 52 arranged on outer surfaces of the capacitive layers 54. The capacitive layers 54 are located between the active material layers 52 and the current collector 56.

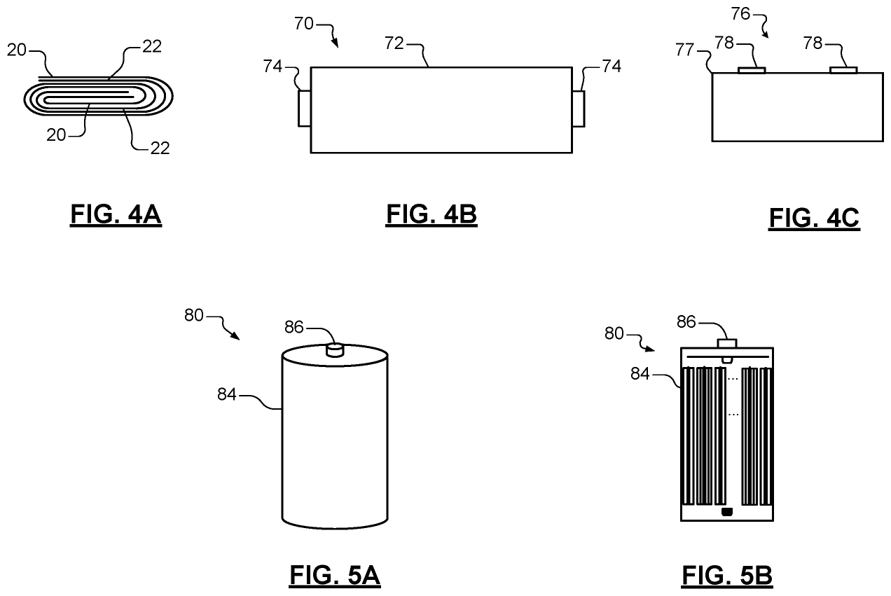

In FIG. 3, the anode electrodes 20 are shown to include a current collector 64 and active material layers 62 arranged on opposite sides of the current collector 64.

In some examples, the current collectors 56 and 64 are made of metal foil, meshed foil, or 3D metal foam. In some examples, the current collector 56 is made of aluminum. In some examples, the current collector 64 is made of copper.

In some examples, single-sided loading of the capacitive layers 54 is in a range from 0.005 to 1 mAh/cm², although other values can be used. In other examples, the single-sided loading of the capacitive layers 54 is in a range from 0.009 to 0.06 mAh/cm², although other values can be used. In some examples, the press density is in a range from 0.3 to 1 g/cc and the porosity is in a range from 45% to 85%, although other values can be used.

In some examples, the loading of the active material layers 52 is in a range from 0.5 to 3 mAh/cm², although other values can be used. In some examples, the press density of the active material layers 52 is in a range from 1.5 to 3.6 g/cc and the porosity is in a range from 25% to 50%, although other values can be used.

In some examples, the capacitive layers 54 are made of carbon materials. In some examples, the carbon materials are selected from a group consisting of activated carbon (AC), graphene, and carbon nanotubes (CNT), although other types of carbon materials can be used. In some examples, the capacitive layers 54 are made of metal oxides (MₓO_{y}, where x and y are integers greater than zero, O is oxygen, and M is a metal). In some examples, the metal in the metal oxides is selected from a group consisting of cobalt (Co), ruthenium (Ru), and niobium (Nb), although other metals can be used. In other examples, the capacitive layers 54 are made of polymers. In some examples, the polymers are selected from a group consisting of polyaniline and polyacetylene, although other polymers can be used. In other examples, the capacitive layers 54 can be made using a combination of two or more materials from the same or different groups of materials.

In some examples, the active material layers of the cabode electrode can include rock salt layered oxides such as LiNiₓMn_{y}Co1−x−yO₂, LiNiₓMn1−xO₂, Li1+xMO₂, NMC111, NMC523, NMC622, MMC721, or other rock salt layered oxides. In other examples, the cathode layers can be made of spinel compounds such as LiMn₂O₄ or other spinel cathode materials. In other examples, the cathode layers can be made of olivine compounds such as LiV₂(PO₄)₃, LiFePO₄, LiMnₓFe1₋ₓPO₄, LiMnPO₄, or other olivine compounds. In other examples, the cathode layers can be made of tavorite compounds such as LiVPO₄F or other tavorite compounds. In other examples, the cathode layers can be made using a combination of two or more materials using a combination of two or more materials from the same group or from different groups of the preceding materials.

The active material layers 62 of the anode electrodes 20 can be made of carbonaceous materials such as graphite and graphene. The active material layers 62 of the anode electrodes 20 can be made of silicon (Si)/graphite, silicon oxide (SiOₓ)/graphite or Si alloy/graphite. The active material layers 62 of the anode electrodes 20 can be made of lithium titanium oxide such as Li₄Ti₅O₁₂. The active material layers 62 of the anode electrodes 20 can be made of metal oxides such as vanadium oxide (V₂O₅), lead oxide (SnO), cobalt oxide (CO₃O₄)) or metal sulfides such as iron sulfide (FeS). The active material layers 62 of the anode electrodes 20 can be made of Si and Si alloy, Si/graphite and lithiated Si, and Si alloy and Si/graphite. In other examples, the active material layers 62 of the anode electrodes 20 can be made using a combination of two or more materials from the same group or from different groups of the preceding materials.

In some examples, the separators 24 comprise outer ceramic layers and a polyethylene (PE) layer sandwiched therebetween, although other materials can be used. In other examples, the separators 24 may include a microporous polymeric separator including a single layer or a multi-layer laminate fabricated from either a dry or a wet process. For example, in certain instances, a single layer of the polyolefin may form the entire separator 24. In other examples, the separator 24 may be a fibrous membrane including a plurality of pores extending between the opposing surfaces and having an average thickness of less than a millimeter. In another example, multiple discrete layers of similar or dissimilar polyolefins may be assembled to form a microporous polymer separator. The separator 24 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 24 as a fibrous layer to help provide the separator 24 with appropriate structural and porosity characteristics.

Various conventionally available polymers and commercial products for forming the separator 24 are contemplated, as well as the many manufacturing methods that may be employed to produce such a microporous polymer separator. In each instance, the separator 24 may have an average thickness greater than or equal to about 5 μm to less than or equal to about 25 μm, and in certain instances, optionally about 20 μm. In certain variations, the separator 24 may have an average thickness greater than or equal to 5 μm to less than or equal to 25 μm, and in certain instances, optionally 20 μm. In each variation, the separator 24 may further include one or more ceramic materials and/or one or more heat resistant materials. For example, the separator 24 may also be admixed with the one or more ceramic materials and/or the one or more heat-resistant materials, or one or more surfaces of the separator 24 may be coated with the one or more ceramic materials and/or the one or more heat resistant materials. The one or more ceramic materials may include, for example, alumina (Al₂O₃), silica (SiO₂), and the like. The heat resistant material may include, for example, Nomex, Aramid, and the like.

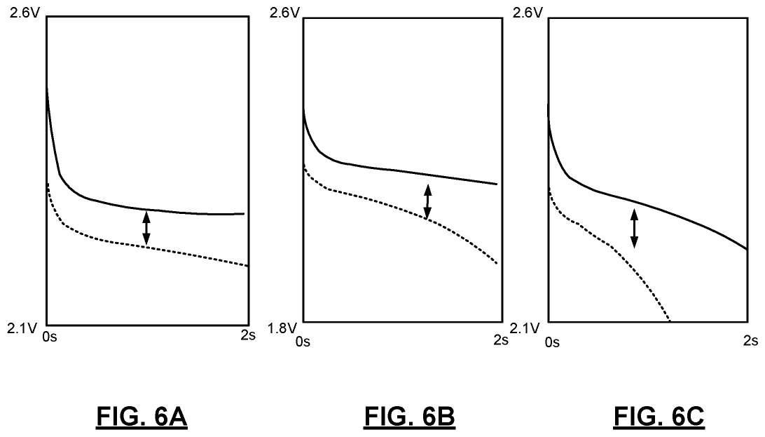

Referring now to FIGS. 4A and 4B, the battery cell can be packaged using a winding cell architecture in a pouch battery cell. In FIG. 4A, a battery cell 70 includes a pouch enclosure 72 and terminals 74 extending from ends of the pouch enclosure 72. In some examples, the pouch enclosure 72 is made of a flexible material. In FIG. 4B, the winding cell includes the anode electrodes 20 and the dual-layered capacitive cabode electrodes 22 are arranged adjacent to one another and folded at a predetermined intervals as shown. In FIG. 4C, the winding cell of FIG. 4B can also be packaged in as a prismatic battery cell. A battery cell 76 includes an enclosure 77 and terminals 78 extending from ends of the enclosure 77.

Referring now to FIGS. 5A and 5B, the battery cell can be packaged in a winding cell architecture for cylindrical battery cells. A battery cell 80 includes a cylindrical housing 84 including terminals 86, 87.

Referring now to FIGS. 6A to 6C, graphs illustrate cold cranking of 1.4 Ah stacked pouch battery cells of FIGS. 1-3 with a capacitor capacity ratio of 1.5% according to the present disclosure and a conventional Li battery cell. In FIG. 6A, at high state of charge (SOC) such as 80% and cold temperatures such as ˜30° C., the battery cell has higher output voltage during cranking. In some examples, the battery cell has 144 mV higher initial cranking voltage at 0.25 s, 62 mV at 10 s and 81 mv at 30 s.

In FIG. 6B, at medium state of charge (SOC) such as 50% and cold temperatures such as ˜30° C., the battery cell also has higher output voltage during cranking. In some examples, the battery cell has 166 mV higher initial cranking voltage at 0.25 s, 86 mV at 10 s and 206 mv at 30 s. In FIG. 6C, at low state of charge (SOC) such as 30% and cold temperatures such as ˜30° C., the battery cell also has higher output voltage during cranking. In some examples, the battery cell has 187 mV higher initial cranking voltage at 0.25 s, 130 mV at 10 s and 264 mv at 19 s.

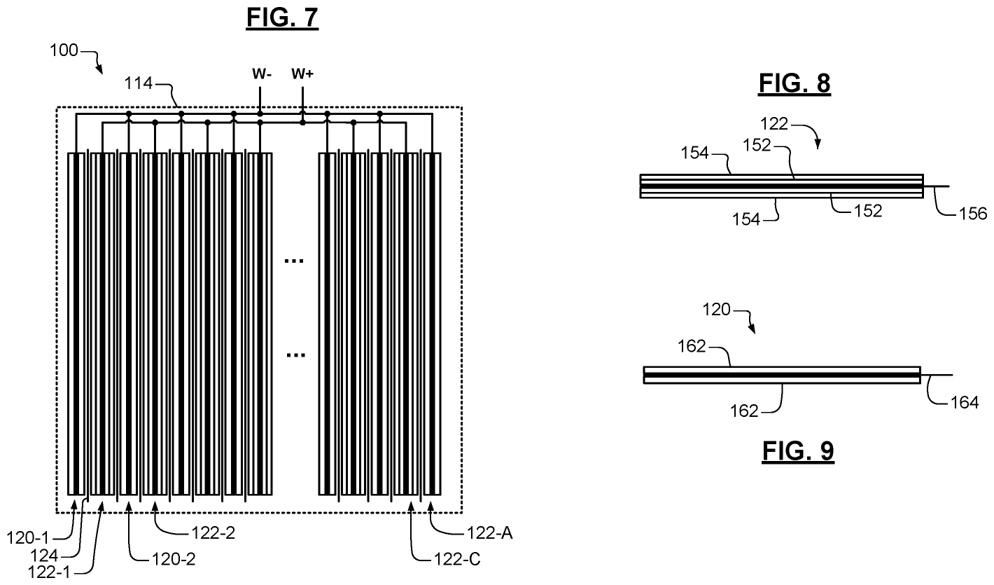

Referring now to FIGS. 7 to 9, another arrangement of the active material layers and the capacitive layers can be used. In this example, the active material layers of the dual-layered capacitive cabode electrodes are located between the capacitive layers and the current collectors. In FIG. 7, a battery cell 100 is arranged in an enclosure 114, and includes anode electrodes 120-1, 120-2, . . . , and 120-A (collectively or individually referred to as anode electrodes 120) and dual-layered capacitive cabode electrodes 122-1, 122-2, . . . and 122-C (collectively or individually referred to as dual-layered capacitive cabode electrodes 122), where A and C are integers greater than zero. In some examples, A is equal to C+1, although other values can be used. The anode electrodes 120 and the dual-layered capacitive cabode electrodes 122 are spaced apart by separators 124 and immersed in electrolyte such as liquid electrolyte or semi solid-state electrolyte.

In FIG. 8, the dual-layered capacitive cabode electrodes 122 are shown to include a current collector 156, active material layers 152 arranged on outer surfaces of the current collector 156, and capacitive layers 154 arranged on outer surfaces of the active material layers 152. The active material layers 152 are located between the capacitive layers 154 and the current collector 156.

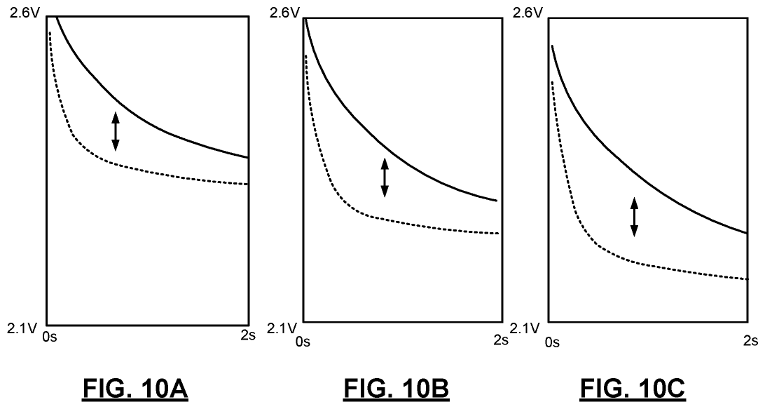

In FIG. 9, the anode electrodes 20 are shown to include a current collector 64 and active material layers 62 arranged on opposite sides of the current collector 64.

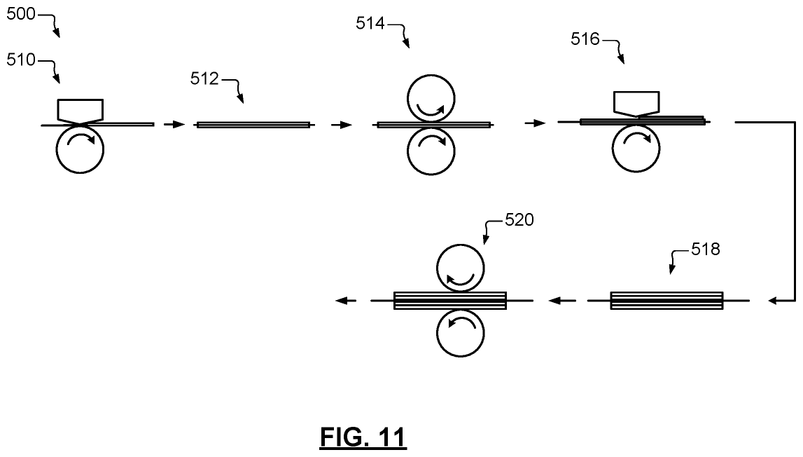

Referring now to FIGS. 10A to 10C, graphs illustrate cold cranking of 1.4 Ah stacked pouch battery cells of FIGS. 7-9 with a capacitor capacity ratio of 1.5% and a conventional Li battery cell. In FIG. 10A, at high state of charge (SOC) such as 80% and cold temperatures such as ˜30° C., the battery cell has higher output voltage during cranking. In some examples, the battery cell has 165 mV higher initial cranking voltage at 0.25 s, 148 mV at 10 s and 98 mv at 30 s.

In FIG. 10B, at medium state of charge (SOC) such as 50% and cold temperatures such as ˜30° C., the battery cell also has higher output voltage during cranking. In some examples, the battery cell has 191 mV higher initial cranking voltage at 0.25 s, 188 mV at 10 s and 231 mv at 30 s. In FIG. 10C, at low state of charge (SOC) such as 30% and cold temperatures such as ˜30° C., the battery cell also has higher output voltage during cranking. In some examples, the battery cell has 218 mV higher initial cranking voltage at 0.25 s, 229 mV at 10 s and 264 mv at 19 s.

Referring now to FIG. 11, a method 500 for manufacturing the battery cells with dual-layered capacitive cabode electrodes of FIGS. 1-6C is illustrated. As can be appreciated, standard battery manufacturing techniques can be used. At 510 and 512, the current collector is coated with a capacitive layer (e.g., activated carbon or other material) and then dried. At 514, the capacitive layer is pressed. At 516 and 518, the active material layer (e.g. LFP or other material) is coated over the capacitive layer and dried. At 520, the active material layer is pressed. Further processing such as notching stacking/winding, injection, formation and/or other steps are performed. As can be appreciated, a similar process can be used for the battery cells with dual-layered capacitive cabode electrodes of FIGS. 7-10C) by rearranging the order of the coating steps.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
C electrodes each including:
a first current collector;
first and second capacitive layers; and
first and second active material layers,
wherein the first and second capacitive layers and the first and second active material layers are arranged on the first current collector; and
E anode electrodes including:
a second current collector; and
third and fourth active material layers arranged on the second current collector,
wherein E and C are integers greater than zero.

2. The battery cell of claim 1, wherein:
the first and second capacitive layers are arranged on outer surfaces of the first current collector, and
the first and second active material layers are arranged on outer surfaces of the first and second capacitive layers, respectively.

3. The battery cell of claim 1, wherein:
the first and second active material layers are arranged on outer surfaces of the first current collector, and
the first and second capacitive layers are arranged on outer surfaces of the first and second active material layers, respectively.

4. The battery cell of claim 1, wherein the battery cell has a stacked architecture.

5. The battery cell of claim 1, wherein E is equal to C+1.

6. The battery cell of claim 1, wherein the C electrodes and the E anode electrodes have a winding cell architecture.

7. The battery cell of claim 1, wherein single-sided loading of the first and second capacitive layers is in a range from 0.005 to 1 mAh/cm².

8. The battery cell of claim 1, wherein a press density of the first and second capacitive layers is in a range from 0.3 to 1 g/cc and porosity of the first and second capacitive layers is in a range from 45% to 85%.

9. The battery cell of claim 1, wherein loading of the first and second active material layers is in a range from 0.5 to 3 mAh/cm².

10. The battery cell of claim 1, wherein a press density of the first and second active material layers is in a range from 1.5 to 3.6 g/cc and porosity of the first and second active material layers is in a range from 25% to 50%.

11. The battery cell of claim 1, wherein the first and second capacitive layers are made of a material selected from a group consisting of activated carbon (AC), graphene, carbon nanotubes (CNT), and combinations thereof.

12. The battery cell of claim 1, wherein the first and second capacitive layers are made of a metal oxide.

13. The battery cell of claim 1, wherein the first and second capacitive layers include a polymer.

14. The battery cell of claim 13, wherein the polymer is selected from a group consisting of polyaniline and polyacetylene.

15. The battery cell of claim 1 wherein the C electrodes include a material selected from a group consisting of a rock salt layered oxide, a spinel compound, an olivine compound, a tavorite compound, and combinations thereof.

16. The battery cell of claim 1, wherein the battery cell is a prismatic battery.

17. The battery cell of claim 1, wherein the battery cell is a cylindrical battery.

18. The battery cell of claim 1, wherein the battery cell is a pouch battery.

19. A battery cell comprising:
C electrodes each including:
a first current collector;
first and second capacitive layers arranged on outer surfaces of the first current collector; and
first and second active material layers arranged on outer surfaces of the first and second capacitive layers, respectively,
wherein the first and second capacitive layers and the first and second active material layers are arranged on the first current collector;
E anode electrodes including:
a second current collector; and
third and fourth active material layers arranged on the second current collector, wherein E and C are integers greater than zero; and
S separators arranged between the C electrodes and the E anode electrodes, where S is an integer greater than zero;
wherein the battery cell is one of a pouch cell, a prismatic cell and a cylindrical

20. A battery cell comprising:
C electrodes each including:
a first current collector;
first and second active material layers arranged on outer surfaces of the first current collector; and
first and second capacitive layers arranged on outer surfaces of the first and second active material layers, respectively,
wherein the first and second capacitive layers and the first and second active material layers are arranged on the first current collector;
E anode electrodes including:
a second current collector; and
third and fourth active material layers arranged on the second current collector, wherein E and C are integers greater than zero; and
S separators arranged between the C electrodes and the E anode electrodes, where S is an integer greater than zero;
wherein the battery cell is one of a pouch cell, a prismatic cell and a cylindrical cell.
